(19) United States
(12) Patent Application Publication
(10) Pub. No.: US 2026/0267909 A1
(43) Pub. Date: Sep. 10, 2026

(54) IMAGE ANALYSIS AND RETRIEVAL METHOD AND APPARATUS

(71) Applicants: Sernet (Suzhou) Technologies Corporation, Jiangsu (CN); Sercomm Corporation, Taipei City (TW)

(72) Inventor: Shaohai ZHAO, Jiangsu (CN)

(21) Appl. No.: 19/449,670

(22) Filed: Jan. 15, 2026

(30) Foreign Application Priority Data
Mar. 7, 2025 (CN) 202510272421.8

(51) Int. Cl. G06F 16/583; G06F 16/51; G06T 1/60; G06T 7/11; G06V 10/25

(52) U.S. Cl. CPC G06F 16/583; G06F 16/51; G06T 1/60; G06T 7/11; G06V 10/25; G06T 2207/10016

(57) ABSTRACT

An image analysis and retrieval method and apparatus are provided. An input data is received and analyzed by artificial intelligence to obtain a plurality of index data corresponding to regions of interest of the input data. The artificial intelligence further analyzes the index data to determine relationships among the regions of interest and divides the input data into a plurality of fragments according to the regions of interest. The fragments, the index data, and the relationships are stored. In response to a user query, the artificial intelligence retrieves the index data to identify one or more matching fragments satisfying the user query. The artificial intelligence further analyzes and combines the matching fragments to obtain related data, and returns the related data corresponding to the matching fragments.

### CROSS-REFERENCE TO RELATED APPLICATION

This application claims the benefit of People's Republic of China application Serial No. 202510272421.8, filed Mar. 7, 2025, the disclosure of which is incorporated by reference herein in its entirety.

### TECHNICAL FIELD

The present invention relates to an image analysis and retrieval method and apparatus.

### BACKGROUND

With the development of artificial intelligence (AI) technologies, challenges are encountered when AI is applied to data processing, particularly efficiency bottlenecks in processing multimedia data such as videos and images. With the rapid advancement of AI technologies, especially breakthroughs in the fields of deep learning and machine learning, AI applications have become increasingly widespread in various fields, such as autonomous driving, intelligent surveillance, and medical diagnosis.

Meanwhile, the volume of data has grown explosively. In particular, multimedia data such as videos and images occupy a large amount of storage space and have complex data formats, thereby requiring more efficient processing and analysis approaches.

A Network Video Recorder (NVR) is a device used to record and store video data received from surveillance cameras. A smart NVR is based on a conventional NVR and incorporates AI analysis functions, enabling intelligent surveillance functions such as facial recognition, license plate recognition, and behavior analysis.

However, a current problem is that most Smart NVR systems record all video and image data onto local hard drives. When AI-based analysis is required, the system must retrieve all video or image data from the hard drive for comprehensive analysis and retrieval.

Such an “after-the-fact analysis” approach is highly inefficient for the following reasons: (1) repetitive processing, in which large volumes of data must be repeatedly read for each analysis, resulting in wasted time; (2) excessive resource consumption, requiring substantial computational resources and imposing high hardware requirements; and (3) time delay, in which slow analysis speeds prevent real-time result delivery.

Accordingly, there is a need for an image analysis and retrieval method and apparatus to improve the foregoing problems.

### SUMMARY

According to one embodiment, an image analysis and retrieval method is provided. The image analysis and retrieval method comprises: receiving an input data; using artificial intelligence to analyze the input data to obtain a plurality of index data corresponding to a plurality of regions of interest of the input data; using artificial intelligence to analyze the plurality of index data corresponding to the plurality of regions of interest of the input data to obtain a relationship among the plurality of regions of interest, and dividing the input data into a plurality of fragments according to the plurality of regions of interest; storing the plurality of fragments, the plurality of index data corresponding to the plurality of regions of interest of the input data, and the relationship among the plurality of regions of interest; according to a user query, using artificial intelligence to retrieve the plurality of index data of the input data and identifying one or more matching fragments corresponding to at least one matching index data that satisfies the user query; further analyzing, by artificial intelligence, the one or more matching fragments to obtain related data of the one or more matching fragments; and combining, by artificial intelligence, the one or more matching fragments and returning the related data of the one or more matching fragments.

According to another embodiment, an image analysis and retrieval apparatus is provided. The image analysis and retrieval apparatus comprises: a storage unit; and a processor coupled to the storage unit. The processor is configured to: receive an input data; use artificial intelligence to analyze the input data to obtain a plurality of index data corresponding to a plurality of regions of interest of the input data; use artificial intelligence to analyze the plurality of index data corresponding to the plurality of regions of interest of the input data to obtain a relationship among the plurality of regions of interest, and divide the input data into a plurality of fragments according to the plurality of regions of interest; store the plurality of fragments, the plurality of index data corresponding to the plurality of regions of interest of the input data, and the relationship among the plurality of regions of interest; according to a user query, use artificial intelligence to retrieve the plurality of index data of the input data and identify one or more matching fragments corresponding to at least one matching index data that satisfies the user query; further analyze, by artificial intelligence, the one or more matching fragments to obtain related data of the one or more matching fragments; and combine, by artificial intelligence, the one or more matching fragments and return the related data of the one or more matching fragments.

### BRIEF DESCRIPTION OF THE DRAWINGS

FIGS. 1A and 1B illustrate flowcharts of an image analysis and retrieval method according to one embodiment of the present application.

FIG. 2 illustrates a functional block diagram of an image analysis and retrieval apparatus according to one embodiment of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification are interpreted in accordance with the customary usage in the relevant technical field. Where certain terms are specifically explained or defined in this specification, the explanations or definitions provided herein shall prevail. Each embodiment of the present disclosure includes one or more technical features. Provided that implementation is feasible, a person having ordinary skill in the art may selectively implement some or all of the technical features of any embodiment, or selectively combine some or all of the technical features of these embodiments.

One embodiment of the present application discloses an innovative data storage and processing solution, which is mainly directed to efficiency issues encountered when artificial intelligence analyzes multimedia data, such as images and videos.

According to one embodiment of the present application, effective fragmentation processing is performed on original multimedia data simultaneously with AI analysis, and the data fragments are stored in an indexed manner. That is, in this embodiment, AI analysis and data fragmentation are performed synchronously. When AI analyzes multimedia data, the data is not processed after the analysis is completed; instead, fragmentation processing is performed in real time during the analysis. The term “fragmentation processing” refers to dividing large data, such as a long video, into smaller portions, for example, based on time intervals or scene changes, so as to facilitate subsequent rapid retrieval and analysis.

In addition, in this embodiment, an index is established for each data fragment. The index may, but is not limited to, recording key information of the data fragment, such as time, location, and content features.

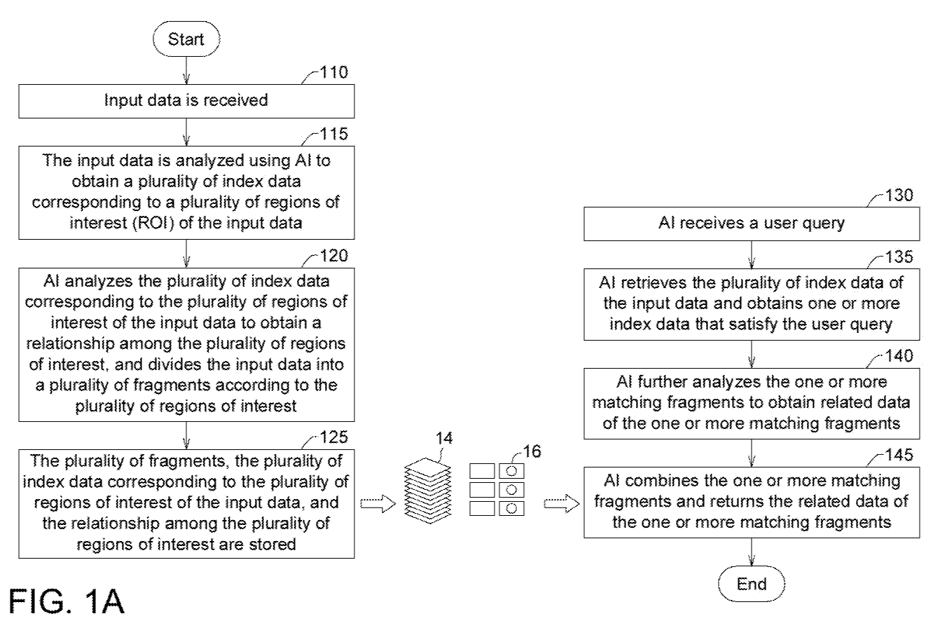

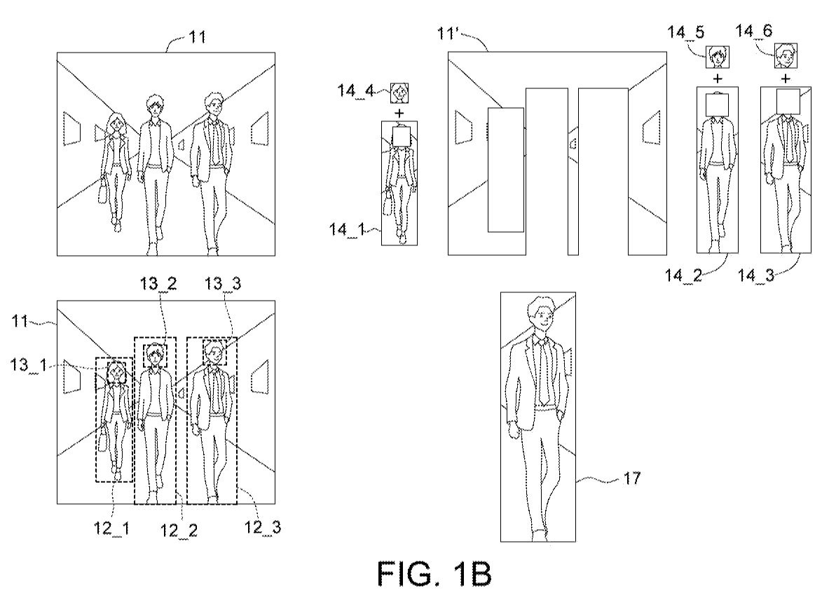

FIGS. 1A and 1B illustrate flowcharts of an image analysis and retrieval method according to one embodiment of the present application. In step 110, input data is received. In this embodiment, the type of the input data includes, but is not limited to, a video or an image 11.

In step 115, the input data is analyzed using AI to obtain a plurality of index data corresponding to a plurality of regions of interest (ROI) of the input data, wherein the plurality of index data represent key information of the plurality of regions of interest of the input data, such as any combination of time, location, and content features. For example, AI analyzes the input data 11 to determine that the input data includes three persons 12_1 to 12_3 and three faces 13_1 to 13_3.

In step 120, AI analyzes the plurality of index data corresponding to the plurality of regions of interest of the input data to obtain a relationship 16 among the plurality of regions of interest, and divides the input data into a plurality of fragments 14 according to the plurality of regions of interest.

In step 125, the plurality of fragments, the plurality of index data corresponding to the plurality of regions of interest of the input data, and the relationship among the plurality of regions of interest are stored. That is, the input data 11’, the plurality of fragments 14_1 to 14_6, and the relationship among the plurality of regions of interest are stored, wherein the input data 11’ represents remaining input data after the plurality of fragments 14_1 to 14_6 are segmented from the input data 11. Each of the plurality of fragments corresponds one-to-one to the plurality of index data.

In step 130, AI receives a user query.

In step 135, AI retrieves the plurality of index data of the input data and obtains one or more index data that satisfy the user query, which may also be referred to as matching index data, and determines one or more matching fragments corresponding thereto.

In step 140, AI further analyzes the one or more matching fragments to obtain related data of the one or more matching fragments, such as clothing or age of a person.

In step 145, AI combines the one or more matching fragments and returns the related data of the one or more matching fragments. For example, AI combines fragments 14_3 and 14_6 that satisfy the query condition into a fragment 17, and returns the fragment 17 and related data thereof to the user.

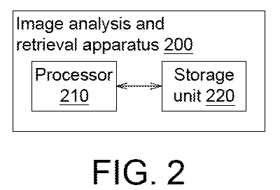

FIG. 2 illustrates a functional block diagram of an image analysis and retrieval apparatus according to one embodiment of the present application. The image analysis and retrieval apparatus 200 includes a processor 210 and a storage unit 220. The processor 210 is coupled to and controls the storage unit 220. The processor 210 is configured to execute the image analysis and retrieval method according to the embodiments of the present application.

In this embodiment, the image analysis and retrieval method and apparatus enable rapid searching of required data, thereby avoiding full scanning of an entire database and saving time and resources.

In addition, this embodiment also achieves efficient utilization of storage resources. Without wasting storage resources, fast and effective support is provided for subsequent retrieval and further AI analysis.

In this embodiment, the system stores data that is useful or valuable for AI and deletes redundant information, thereby saving a significant amount of hard disk space. When data needs to be retrieved again, target fragments can be quickly located according to the indexes, rather than rescanning the entire video or image repository.

In this embodiment, when further AI analysis is performed, such as model retraining or deep detection, the system can rapidly retrieve the required data, thereby greatly reducing computation time.

Application scenarios of this embodiment include, but are not limited to, AI surveillance, network cameras, and video recording storage. These applications can reduce storage costs without affecting computational capability and efficiency. When applied to AI surveillance, the image analysis and retrieval method and apparatus of this embodiment can be used for evidence collection and event triggering in the future through AI analysis and video storage. When applied to network cameras, the image analysis and retrieval method and apparatus of this embodiment reduce storage costs through AI analysis and video storage.

The image analysis and retrieval method and apparatus of this embodiment can be implemented on hardware having computational capability, including computers, embedded systems, and cloud storage.

In summary, the embodiments of the present application not only save storage space, but also significantly improve retrieval and analysis efficiency, thereby addressing challenges faced by AI in multimedia big data analysis.

The foregoing description mainly describes the solutions provided by the embodiments of the present application from the perspective of an image analysis and retrieval apparatus. It should be understood that, in order to implement the foregoing functions, the image analysis and retrieval apparatus includes corresponding hardware structures and/or software modules that perform the functions. Those skilled in the art will readily appreciate that, in combination with the units and algorithm steps described in the embodiments of the present specification, the present application may be implemented in hardware form or in a combination of hardware and computer software. Whether a function is performed by hardware or by hardware driven by computer software depends on the specific application and design constraints of the technical solution. Those skilled in the art may use different methods to implement the functions described for each specific application, but such implementations should not be construed as exceeding the scope of the present application.

In this embodiment, the image analysis and retrieval apparatus is divided into functional modules based on the foregoing method examples. For example, each functional module may be obtained by dividing according to each corresponding function, or two or more functions may be integrated into a single processing module. The integrated module may be implemented in hardware form or in the form of a software functional module. It should be noted that, in the embodiments of the present application, the division into modules is merely an example and represents a logical function division. Other division methods may be used in actual implementation. The following description uses an example in which each functional module is obtained by dividing according to each corresponding function.

Although many specific details may be described herein, they should not be construed as limiting the scope of the claimed invention, but rather as descriptions of features of specific embodiments. Certain features described in the context of a single embodiment may also be implemented in combination in a single embodiment. Conversely, various features described in the context of a single embodiment may also be implemented separately or in any suitable sub-combination in multiple embodiments. Furthermore, although operations may be depicted in the drawings as being performed in a particular order, this should not be understood as requiring such operations to be performed in the specific order shown or in sequential order, or as requiring all illustrated operations to be performed to achieve desired results.

Although the foregoing embodiments disclose only certain examples and implementations, various changes, modifications, and enhancements may be made based on the disclosed content.

Of course, the present invention may have various other embodiments. Without departing from the spirit and essential characteristics of the present invention, those skilled in the art may make various corresponding changes and modifications, and such changes and modifications shall fall within the scope of protection of the appended claims.

What is claimed is:

1. An image analysis and retrieval method, comprising:
receiving an input data;
using artificial intelligence to analyze the input data to obtain a plurality of index data corresponding to a plurality of regions of interest of the input data;
using artificial intelligence to analyze the plurality of index data corresponding to the plurality of regions of interest of the input data to obtain a relationship among the plurality of regions of interest, and dividing the input data into a plurality of fragments according to the plurality of regions of interest;
storing the plurality of fragments, the plurality of index data corresponding to the plurality of regions of interest of the input data, and the relationship among the plurality of regions of interest;
according to a user query, using artificial intelligence to retrieve the plurality of index data of the input data and identifying one or more matching fragments corresponding to at least one matching index data that satisfies the user query;
further analyzing, by artificial intelligence, the one or more matching fragments to obtain related data of the one or more matching fragments; and
combining, by artificial intelligence, the one or more matching fragments and returning the related data of the one or more matching fragments.

2. The image analysis and retrieval method according to claim 1, wherein the plurality of index data are key information of the plurality of regions of interest of the input data, and the key information comprises any combination of time, location, and content features.

3. The image analysis and retrieval method according to claim 1, wherein the input data comprises a video or an image.

4. An image analysis and retrieval apparatus, comprising:
a storage unit; and
a processor coupled to the storage unit,
wherein the processor is configured to:
receive an input data;
use artificial intelligence to analyze the input data to obtain a plurality of index data corresponding to a plurality of regions of interest of the input data;
use artificial intelligence to analyze the plurality of index data corresponding to the plurality of regions of interest of the input data to obtain a relationship among the plurality of regions of interest, and divide the input data into a plurality of fragments according to the plurality of regions of interest;
store the plurality of fragments, the plurality of index data corresponding to the plurality of regions of interest of the input data, and the relationship among the plurality of regions of interest;
according to a user query, use artificial intelligence to retrieve the plurality of index data of the input data and identify one or more matching fragments corresponding to at least one matching index data that satisfies the user query;
further analyze, by artificial intelligence, the one or more matching fragments to obtain related data of the one or more matching fragments; and
combine, by artificial intelligence, the one or more matching fragments and return the related data of the one or more matching fragments.

5. The image analysis and retrieval apparatus according to claim 4, wherein the plurality of index data are key information of the plurality of regions of interest of the input data, and the key information comprises any combination of time, location, and content features.

6. The image analysis and retrieval apparatus according to claim 4, wherein the input data comprises a video or an image.
